(19) United States
(12) Patent Application Publication
(10) Pub. No.: US 2025/0067353 A1
(43) Pub. Date: Feb. 27, 2025

(54) MULTI-PORT VALVE WITH PROPORTIONAL FLOW FUNCTION

(71) Applicant: JOHNSON ELECTRIC INTERNATIONAL AG, Murten (CH)

(72) Inventors: Emmanuel VUICHARD, Epagny (CH); Adrien AYMON, Murten (CH); Charlène GOMEZ, Villars-sur-Glâne (CH)

(21) Appl. No.: 18/828,275

(22) Filed: Sep. 9, 2024

Related U.S. Application Data
(63) Continuation of application No. PCT/EP2022/055687, filed on Mar. 7, 2022.

(51) Int. Cl. F16K 11/085

(52) U.S. Cl. CPC F16K 11/0856

(57) ABSTRACT

The invention relates to a multi-port valve comprising a valve housing having an axial port and a plurality of circumferential ports, and a valve member having at least two flow channels therethrough. The valve member is movable within the valve housing about an axis to alter a fluid flow through the multi-port valve by changing the position of the at least two flow channels. At least one dedicated proportional flow condition is achievable between the plurality of circumferential ports. There is also a sealing arrangement positioned between the valve housing and the valve member, the valve member being movable relative to the sealing arrangement. The sealing arrangement comprises a seal associated with each of the plurality of circumferential ports. The seal associated with a second lower circumferential port is a surge seal which is provided as part of an elongate sealing element having a central seal and transitionary seal panels either side of a sealing rib of the central seal with respect to the circumferential direction.

### CROSS REFERENCE TO RELATED APPLICATIONS

This non-provisional patent application is continuation application of PCT Application No. PCT/EP2022/055687, filed with the European Patent Office on Mar. 7, 2022, which is incorporated herein by reference in their entirety.

### FIELD OF THE INVENTION

The present invention relates to a multi-port valve, particularly but not necessarily exclusively for use in coolant circuits for motor vehicles. The invention further relates to a coolant system for a motor vehicle, in particular, for an electric vehicle.

### BACKGROUND

Proportional regulation of coolant flow within an engine of a motor vehicle is typically controlled by a three-way valve. Coolant is proportionally directed from the main coolant circuit between the battery/electrical drive unit loop and the radiator. A further valve is then provided which allows for crossing functionality. This is usually a four-way valve which allows diversion of incoming flow to the various components requiring cooling, for instance, between the battery and the electrical drive unit, and will typically have one inlet from the proportional regulation valve, and another from another system within the circuit.

This arrangement requires multiple actuators to operate the different valves, creating significant amounts of infrastructure, as additional connecting pipework or tubing is required, and pressure drops in the system result in a bulkier set-up and a higher overall cost.

There is an additional issue associated with proportional regulation of the coolant flow, in that, when the valve member is in a transitionary state, the back-pressure at the inlets of the valve can result in a fluid hammer effect as pressure builds up behind the inlet whilst the port to the valve is blocked. For quieter vehicles, particularly electric vehicles, water hammer can create a surprising and distracting noise for the driver, and therefore minimising the noise created by the fluid hammer effect is desirable.

### SUMMARY OF THE INVENTION

It is an object of the present invention to provide a multi-port valve which is able to overcome or obviate the above-referenced issues.

According to a first aspect of the invention, there is provided a multi-port valve comprising: a valve housing having an axial port and a plurality of circumferential ports; a valve member having at least two flow channels therethrough, the valve member being movable within the valve housing about an axis to alter a fluid flow through the multi-port valve by changing the position of the at least two flow channels, wherein at least one dedicated proportional flow condition is achievable between the plurality of circumferential ports; and a sealing arrangement positioned between the valve housing and the valve member, the valve member being movable relative to the sealing arrangement, the sealing arrangement comprising a seal associated with each of the plurality of circumferential ports; characterised in that the valve member includes at least one surge-prevention opening therein to provide a surge-prevention pathway to the axial port.

The present invention is a multi-port valve which is designed to firstly reduce number of actuators used in a vehicular coolant system, by providing a valve arrangement which is capable of both proportional and crossing flow functionality. The use of surge-prevention openings, either as part of the sealing arrangement or as part of the valve member itself, provides a means of obviating issues associated with fluid hammer effects. The surge-prevention openings provide leak pathways from pressurised ports through to the axial port in particular during transitional rotational positions of the valve. As such, the noise generated by fluid hammer effects is drastically reduced, and the valve becomes more appropriate to use in quiet vehicles, such as electric vehicles. The term dedicated proportional flow condition is intended to refer to a valve position in which proportional flow is desirable, and therefore is an intended use condition of the valve. It will be appreciated that valves in the art may, due to inadequate sealing arrangements or intermediate transitionary valve positions, create unintentional pseudo-proportional flow conditions. This is not the intention of the present invention.

Preferably, the at least one surge-prevention opening may be non-circular.

The surge-prevention openings may be designed to simultaneously overlap with a corresponding port whilst a circumferential opening is still in partial overlap. It may therefore be desirable, to create consistent acoustic behaviour, that the total overlap of openings in the valve member with the port is constant or substantially constant during transitional rotation of the valve member.

More preferably, the at least one surge-prevention opening may be trapezoidal in the circumferential direction of the valve member.

A trapezoidal shape may increase in area overlap with rotational position, which provides the necessary area increase as port overlap with the circumferential openings decreases.

The plurality of circumferential ports may preferably comprise at least one upper circumferential port and at least one lower circumferential port, the upper and lower circumferential ports being spaced apart in the axial direction of the valve member.

The radial dimension of the valve can be constrained if there is more scope for positioning of flow channels in the valve member through the axial direction. By spacing the circumferential ports apart in the axial direction, alternative proportionality behaviour can be achieved, since more space can be devoted to alternative flow channels in the valve member. Axial spacing enables openings to be at the same circumferential position of the valve member, whilst remaining fluidly isolated.

Optionally, there may be two said upper circumferential ports and two said lower circumferential ports.

Paired upper and lower ports can be provided which can be interconnected by bounded flow channels. This creates different and dedicated proportional behaviour, in which overlap between proximate flow channels with individual inlet ports creates the proportional flow, rather than overlap of an individual flow channel with proximate outlet ports.

The seal associated with the first lower circumferential port may be dimensioned to the first lower circumferential port.

In this arrangement, it is preferred that at least one of the ports not include any unusual sealing behaviour, so that a predictable flow thereacross can be maintained.

Preferably, the seal associated with the second lower circumferential port may be provided as part of an elongate sealing element having a central seal and transitionary seal panels either side of a sealing rib of the central seal with respect to the circumferential direction.

An elongate sealing element has the advantage of inhibiting cross-leakage between circumferential openings of the valve member during dedicated proportional flow conditions. Since the circumferential openings only partially overlap with the inlet port in the dedicated proportional flow condition, to avoid leaks, there needs to be a sealing portion for the non-overlapping area of the circumferential openings. This sealing element structure provides this sealing behaviour.

In an optional embodiment, the elongate sealing member may include intermediate sealing ribs in the transitionary seal panels to prevent leak between adjacent the at least one surge-prevention opening and at least one circumferential opening of the valve member during movement of the valve member.

The intermediate sealing ribs are designed to prevent leakage from the circumferential openings into the surge-prevention openings during transitionary movement of the valve member.

Optionally, the elongate sealing element may further comprise an at least in part perimetric seal.

The provision of a perimetric seal complements the intermediate sealing ribs, providing closed regions of the sealing element where cross-leakage between ports during transitional motion of the valve member can be prevented.

Preferably, the seal associated with the first and/or second circumferential ports may be provided on a seal element having a single transitionary seal panel to one side of a sealing rib of the seal in one circumferential direction.

As with the elongate sealing member, there is a need to provide sealing behaviour laterally of the outlet ports of the valve when there is incomplete overlap between the port and the corresponding circumferential opening. However, the structure of the valve member may be such that the bounded flow channel will be blocked at the opposing end for rotation in one circumferential direction, negating the need for a larger sealing element.

The seal associated with the first and/or second upper circumferential ports may further comprise an at least in part perimetric seal.

The perimetric seal can provide a closed region of the sealing element where cross-leakage from the upper level of the valve to the lower level during transitional motion of the valve member can be prevented.

The valve member may comprise first and second said flow channels, the first flow channel extending from a first lower circumferential opening to a first upper circumferential opening of the valve member, and the second flow channel extending from a second lower circumferential opening to a second upper circumferential opening of the valve member.

Bounded flow channels, such as those described here, provide a good means of permitting proportional flow behaviour in a confined radius.

Preferably, the valve member may further comprise a third flow channel formed as a void extending from a third lower circumferential opening to an axial opening, the at least one surge-prevention opening being fluidly communicable with the void.

A void volume within the valve member provides a region in which discharge can readily occur to an axial port, which is particularly suited towards receiving surge overflow in conditions in which surge behaviour is present.

There may be at least one proportional flow condition from the first lower circumferential port to the first and second upper circumferential ports, and at least one proportional flow condition from the second lower circumferential port to the first and second upper circumferential ports.

This alternative valve member configuration advantageously produces multiple possible proportional flow conditions, which can be easily utilised in an appropriate system.

Each seal may be provided as a protruding rim relative to a surface of an associated sealing element.

The provision of a protruding rim or lip on the sealing elements advantageously provides a sealing effect with the valve member, without inhibiting the rotation movement thereof.

According to a second aspect of the invention, there is provided a coolant system for a motor vehicle, the coolant system comprising at least one multi-port valve in accordance with the first aspect of the invention.

The need for proportional and crossing behaviour is keenly felt in the coolant circuit arrangement of motor vehicles, and as such, the present invention is highly suited towards integration into such a system.

Preferably, the motor vehicle may be an electric vehicle.

Electric vehicles are noticeably quiet, and therefore the effect of fluid hammer noise in the coolant system is far more noticeable. The present invention has been designed with this problem in mind.

### BRIEF DESCRIPTION OF THE DRAWINGS

The invention will now be more particularly described, by way of example only, with reference to the accompanying drawings, in which:

FIG. 1 shows a front perspective view of a valve member and sealing arrangement suitable for use in an embodiment of a multi-port valve in accordance with the first aspect of the invention;

FIG. 2 shows a side view of the valve member of FIG. 1;

FIG. 3 shows a vertical cross-section through the valve member of FIG. 1;

FIGS. 4A and 4B respectively show cross-sections through first and second horizontal levels A-A and B-B of the multi-port valve of FIG. 1;

FIGS. 5A and 5B show a diagrammatic representation of first and second lower sealing element of the multi-port valve of FIG. 1;

FIGS. 5C and 5D show a diagrammatic representation of first and second upper sealing element of the multi-port valve of FIG. 1;

FIGS. 6A and 6B respectively show cross-sections through first and second horizontal levels of the multi-port valve of FIG. 1, in a first proportional flow condition;

FIG. 6C shows a diagrammatic representation of the cross-linking between the ports shown in FIGS. 6A and 6B;

FIGS. 7A and 7B respectively show cross-sections through first and second horizontal levels of the multi-port valve of FIG. 1, in a first outlet-blocked condition;

FIG. 7C shows a diagrammatic representation of the cross-linking between the ports shown in FIGS. 7A and 7B;

FIGS. 8A and 8B respectively show cross-sections through first and second horizontal levels of the multi-port valve of FIG. 1, in a second outlet-blocked condition;

FIG. 8C shows a diagrammatic representation of the cross-linking between the ports shown in FIGS. 8A and 8B;

FIGS. 9A and 9B respectively show cross-sections through first and second horizontal levels of the multi-port valve of FIG. 1, in a second proportional flow condition;

FIG. 9C shows a diagrammatic representation of the cross-linking between the ports shown in FIGS. 9A and 9B;

FIGS. 10A and 10B respectively show cross-sections through first and second horizontal levels of the multi-port valve of FIG. 1, in a first non-proportional flow condition;

FIG. 10C shows a diagrammatic representation of the cross-linking between the ports shown in FIGS. 10A and 10B;

FIGS. 11A and 11B respectively show cross-sections through first and second horizontal levels of the multi-port valve of FIG. 1, in a second non-proportional flow condition;

FIG. 11C shows a diagrammatic representation of the cross-linking between the ports shown in FIGS. 11A and 11B;

FIGS. 12A and 12B respectively show cross-sections through first and second horizontal levels of the multi-port valve of FIG. 1, in a transitionary surge-prevention condition;

FIG. 12C shows a diagrammatic representation of the cross-linking between the ports shown in FIGS. 12A and 12B;

FIG. 13 shows a front perspective view of an alternative valve member suitable for use in the embodiment of the multi-port valve of FIG. 1;

FIG. 14 shows a front perspective view of a further alternative valve member suitable for use in the embodiment of the multi-port valve of FIG. 1; and

FIG. 15 shows a front perspective view of a yet further alternative valve member suitable for use in the embodiment of the multi-port valve of FIG. 1.

### DETAILED DESCRIPTION OF THE PREFERRED EMBODIMENTS

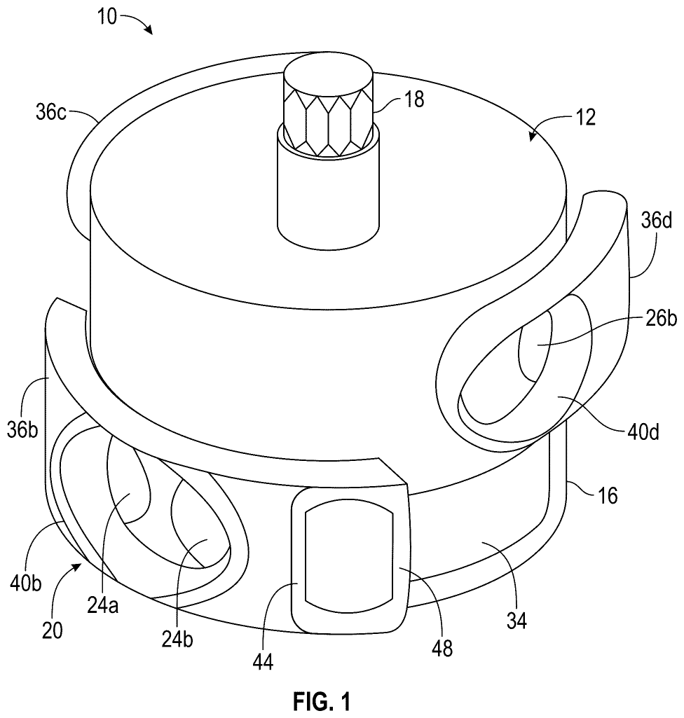

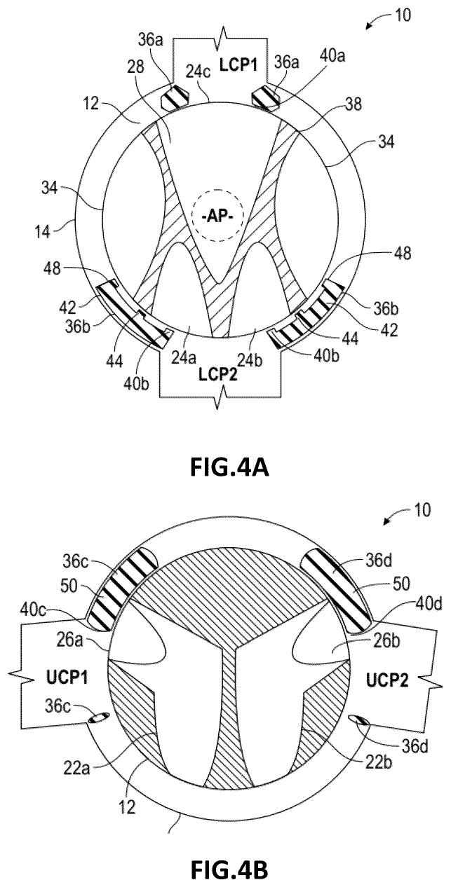

Referring firstly to FIG. 1, there is shown part of a multi-part valve, referenced globally at 10, indicated as a valve member 12 outside of its corresponding valve housing 14, which can be seen in the cross-section shown in FIGS. 4A and 4B.

The valve member 12 has a body 16 which is cylindrical, being drivable via an actuator through its shaft 18. The shaft 18 may have a key or similar non-circular engagement portion for rotationally locking to a drive output of the associated actuator.

A corresponding sealing arrangement 20 for the multi-port valve 10 is illustrated in FIG. 1, in the absence of the housing 14.

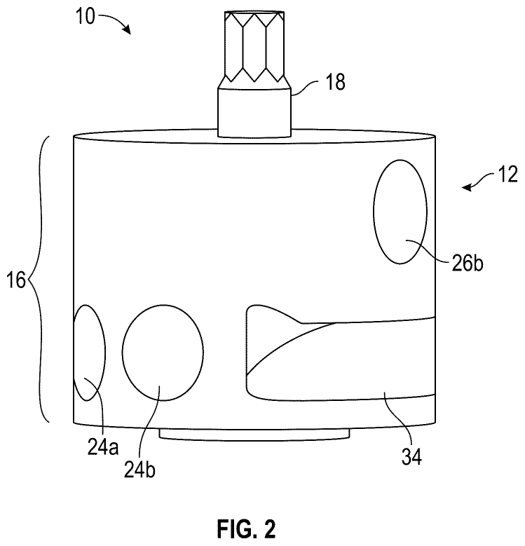

The body 16, as can be seen in FIG. 2, has a first flow channel 22a therethrough which extends between a first lower circumferential opening 24a and a first upper circumferential opening 26a. The body 16 has a greater axial extent than that of the first embodiment, with the first flow channel 22a extending through the body 16 in three-dimensional space. The terms upper and lower here are used with respect to the shaft 18 position, and do not indicate any intended in-use orientation for the multi-port valve 10. This notation is merely used to denote axial spacing between the said upper and lower openings.

There is a second flow channel 22b which extends between a second lower circumferential opening 24b and a second upper circumferential opening 26b.

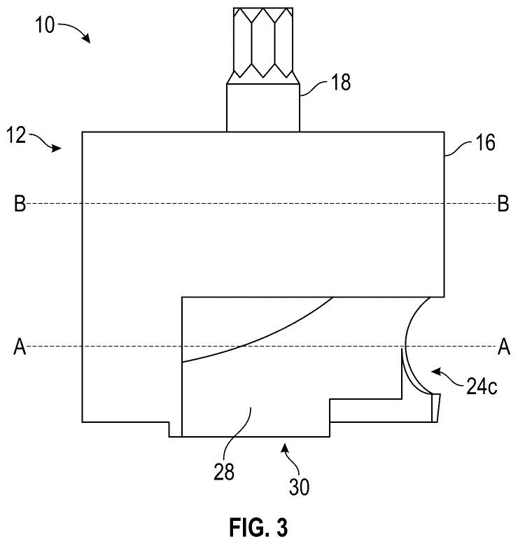

A third lower circumferential opening 24c is also provided, which is in fluid communication with a lower void 28 of the body 16, and which discharges into an axial opening 30 which in turn opens out through a base of the body 16. This is best illustrated in FIG. 3. The second flow channel 22b thus directs flow in a substantially different direction to the first flow channel 22a, from a lower level of the valve member 12 to an upper level thereof.

On the lower level of the body 16 is provided at least one, and preferably a plurality of surge-prevention openings 34 which are in close angular proximity to the first and second lower circumferential openings 24a, 24b. In the embodiment depicted in FIGS. 1 to 3, the surge-prevention openings 32 are substantially rectilinear, extending circumferentially either side of the first and second lower circumferential openings 24a, 24b. The surge-prevention openings 32 are fluidly-communicable with the lower void 28, so that fluid passing therethrough discharges into the axial opening 30.

FIGS. 4A and 4B respectively show lower and upper cross-sections at planes A-A and B-B respectively through the multi-port valve 10 of FIG. 1. FIG. 4A shows the positions of the first and second lower circumferential ports LCP1, LCP2, with accompanying first and second lower sealing elements 36a, 36b being positioned in a valve housing 14 and held relative to the valve member 12. The first and second lower sealing elements 36a, 36b are, here, diametrically opposed to one another. The position of the axial port AP is indicated in dashed lines, being in communication with the lower void 28. Whilst structural ribs 38 of the body 16 are shown in FIG. 4A, the surge-prevention openings 34 are fluidly communicable with the lower void 28.

FIG. 4B shows the positions of the first and second upper circumferential ports UCP1, UCP2 and the accompanying first and second upper sealing elements 36c, 36d. The positions of the first and second flow channels 22a, 22b extending up from the horizontal plane are shown in FIG. 4A. The sealing elements 36a, 36b, 36c, 36d are formed from a resilient material.

FIGS. 5A and 5B show a diagrammatic representation of first and second lower sealing element of the multi-port valve of FIG. 1.

The first lower sealing element 36a is provided having a traditional ring seal 40a, which is dimensioned to the size of the first lower circumferential port LCP1. The sealing rim or lip of seal 40a is therefore entirely positioned at the perimeter of the sealing element 36a. The sealing rims of the seals 40a, 40b, 40c, 40d are shown in hatching, which is indicative of how the seals 40a, 40b, 40c, 40d protrude from the rest of the corresponding sealing elements 36a, 36b, 36c, 36d, that is, extend in an in-use radial direction of the multi-part valve 10 to provide a sealing effect against the valve member 12 and/or valve housing 14. The second lower sealing element 36b is a far more complicated structure.

The second lower sealing element 36b comprises a central seal 40b which is dimensioned to the size of the second lower circumferential port LCP2. Said central seal 40b thus has a sealing rim or lip which mates against the second lower circumferential port LCP2. However, the second lower sealing element 36b extends laterally either side of the sealing lip or rim of the seal 40b, with the transitionary seal panels 42 being designed to provide sealing during movement of the valve member 12 where port-to-port leakage might undesirably occur. Furthermore, there are intermediate ribs 44 provided within the transitionary seal panels 42 which serve to isolate the surge-prevention openings 34 from other lower circumferential openings during rotation of the valve member 12. A perimetric seal 48 extends around the circumference of the second sealing element 36b.

FIGS. 5C and 5D show a diagrammatic representation of first and second upper sealing element of the multi-port valve of FIG. 1. The first and second upper sealing elements 36c, 36d have seals 40c, 40d having sealing rims or lips which are dimensioned to the sizes of the first and second upper circumferential ports UCP1, UCP2 respectively. The first and second upper sealing elements 36c, 36d also include transitionary seal panels 50. The transitionary seal panels 50 extend in only one lateral direction from the, preferably protruding, sealing lips or rims of the seals 40c, 40d. A perimetric seal 52 extends around the circumference of the third and fourth sealing elements 36c, 36d.

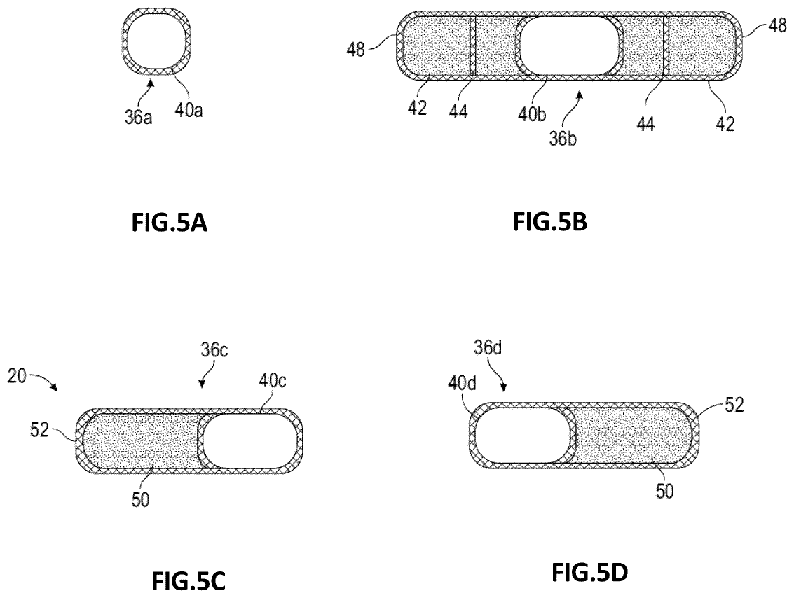

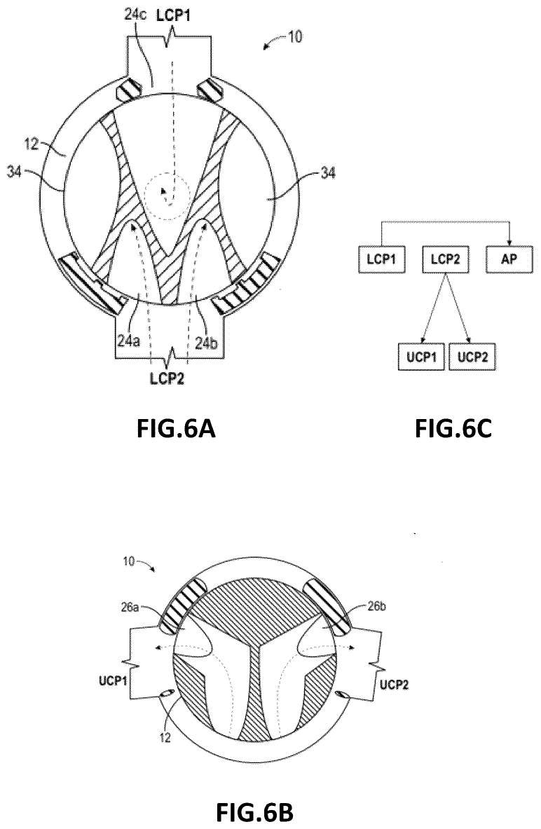

The multi-port valve 10 is able to combine the crossing function and proportional function which are currently provided in engine coolant systems using a single valve, and thus, a single actuator. Various examples of useful valve positions are illustrated in FIGS. 6 to 12, with the dashed arrows indicating fluid flow direction.

In a typical arrangement, the first lower circumferential port LCP1 would be connected to an inlet from a first coolant loop, and therefore would generally act as an inlet port. The second lower circumferential port LCP2 would also generally act as an inlet port, usually being an inlet from a second coolant loop, perhaps to another valve on the circuit. The first upper circumferential port UCP1 might be a radiator outlet, with the second upper circumferential port UCP2 being directed to the first loop which is directed to the battery/electrical drive unit part of the circuit. Proportional flow between the first and second upper circumferential ports UCP1, UCP2 is therefore desirable. The axial port AP would typically be an outlet to the said second coolant loop. As such, it is expected that pressure build-up would occur during transitional valve member positions primarily at the first and second lower circumferential ports LCP1, LCP2.

FIGS. 6A and 6B show a first proportional flow condition of the multi-port valve 10, with FIG. 6C showing the flow pathways between the ports. Flow from the first lower circumferential port LCP1 proceeds into the lower void 28 and out through the axial port AP.

Flow from the second lower circumferential port LCP2 is diverted between the first and second lower circumferential openings 24a, 24b in a proportional relationship through the first and second flow channels 22a, 22b and out of the first and second upper circumferential openings 26a, 26b, which are aligned to the first and second upper circumferential ports UCP1, UCP2 respectively.

Notably, the presence of the intermediate ribs 44 in the second lower sealing element 36b inhibits leak paths across the transitionary seal panels 42 and into the surge-prevention openings 34. This more complicated seal geometry allows for the surge-prevention openings 34 to be relatively proximate to the first and second lower circumferential openings 24a, 24b without introducing otherwise undesirable leak paths.

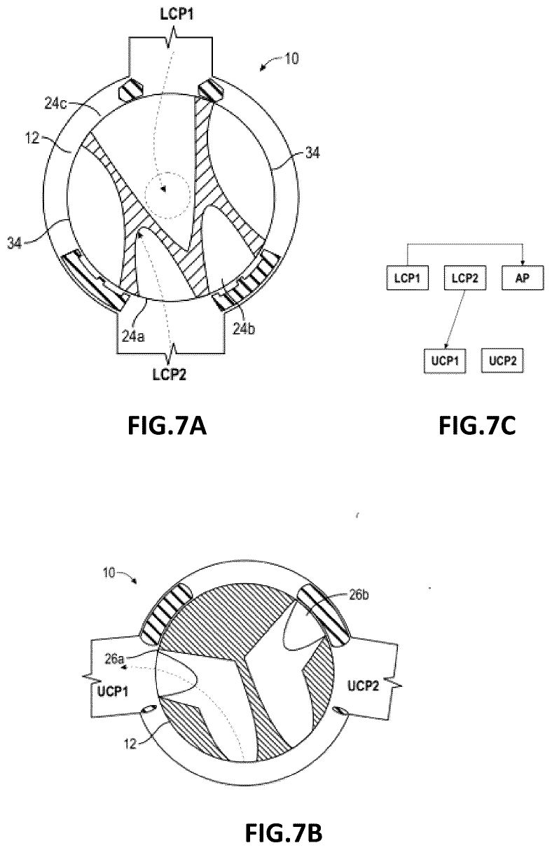

A counter-clockwise rotation of the valve member 12 is illustrated in FIGS. 7A to 7C, in which the first lower circumferential opening 24a is completely overlapping with the second lower circumferential port LCP2. The second lower circumferential opening 24b is thus completely blocked by a transitionary seal panel 42 of the second lower sealing element 36b. Flow proceeds directly from the second lower circumferential port LCP2 to the first upper circumferential port UCP1.

Conversely, since the third lower circumferential opening 24c is much larger than the first lower circumferential port LCP1, it remains in communication with the lower void 28, and thus flow is maintained from the first lower circumferential port LCP1 to the axial port AP.

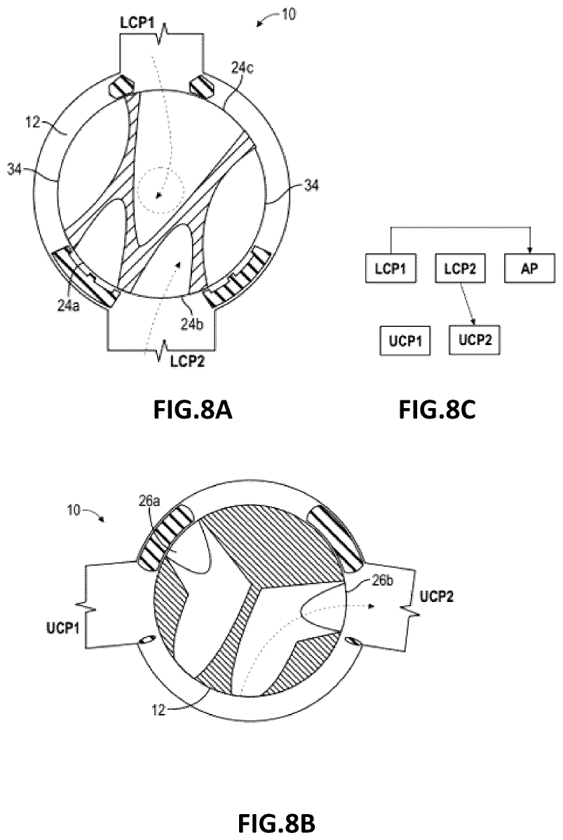

The corresponding clockwise rotation of the valve member 12 is illustrated in FIGS. 8A to 8C, in which the second lower circumferential opening 24b is completely overlapping with the second lower circumferential port LCP2. The first lower circumferential opening 24a is thus completely blocked by a transitionary seal panel 42 of the second lower sealing element 36b. Flow proceeds directly from the second lower circumferential port LCP2 to the second upper circumferential port UCP2.

Again, since the third lower circumferential opening 24c is much larger than the first lower circumferential port LCP1, it remains in communication with the lower void 28, and thus flow is maintained from the first lower circumferential port LCP1 to the axial port AP.

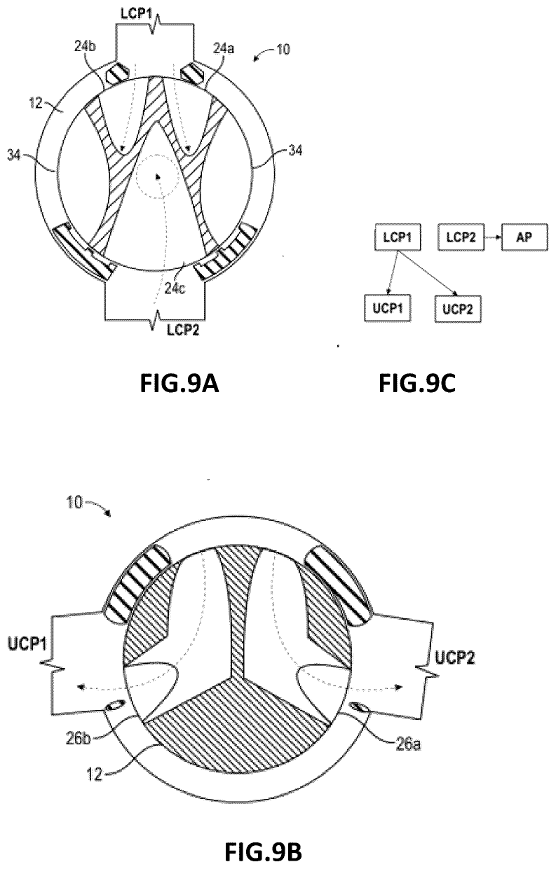

An alternative proportional flow condition is illustrated in FIGS. 9A to 9C, in which the valve member 12 is positioned at 180° relative to that shown in FIGS. 6A and 6B. Proportional flow thus occurs from the first lower circumferential port LCP1 to the first and second upper circumferential ports UCP1, UCP2. Flow can then occur from the second lower circumferential port LCP2 through the lower void 28 to the axial port AP.

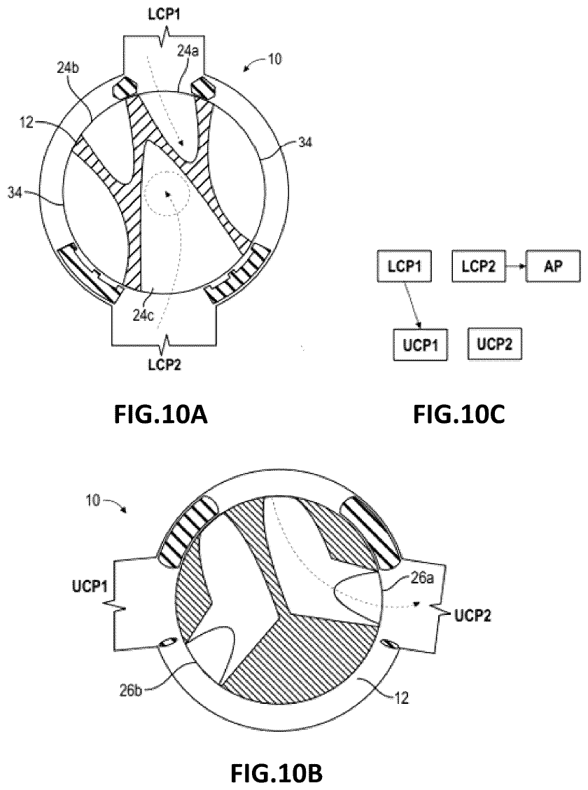

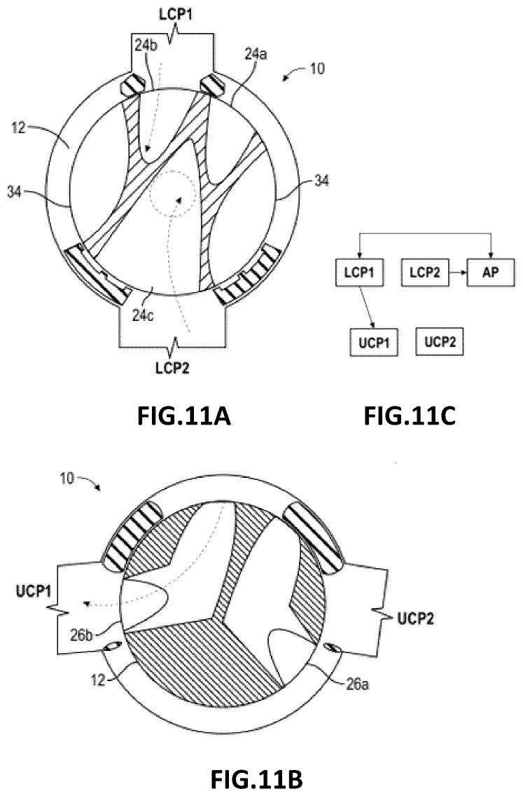

The counterpart limits of the proportional flow in which one or other flow channel 22a, 22b is blocked are shown in FIGS. 10A to 10C and 11A to 11C respectively. In FIGS. 10A to 10C there has been a counter-clockwise rotation which aligns the first lower circumferential opening 24a with the first lower circumferential port LCP1 completely, with flow proceeding via the first flow channel 22a to the second upper circumferential port UCP2. The second lower circumferential opening 24b is non-aligned to the first lower circumferential port LCP1.

Since the third lower circumferential opening 24c is much larger than the second lower circumferential port LCP2, it remains in communication with the lower void 28, and thus flow is maintained from the second lower circumferential port LCP2 to the axial port AP.

The clockwise rotation is shown in FIGS. 11A to 11C which aligns the second lower circumferential opening 24b with the first lower circumferential port LCP1 completely, with flow proceeding via the second flow channel 22b to the first upper circumferential port UCP1. The first lower circumferential opening 24a is non-aligned to the first lower circumferential port LCP1.

Again, since the third lower circumferential opening 24c is much larger than the second lower circumferential port LCP2, it remains in communication with the lower void 28, and thus flow is maintained from the second lower circumferential port LCP2 to the axial port AP.

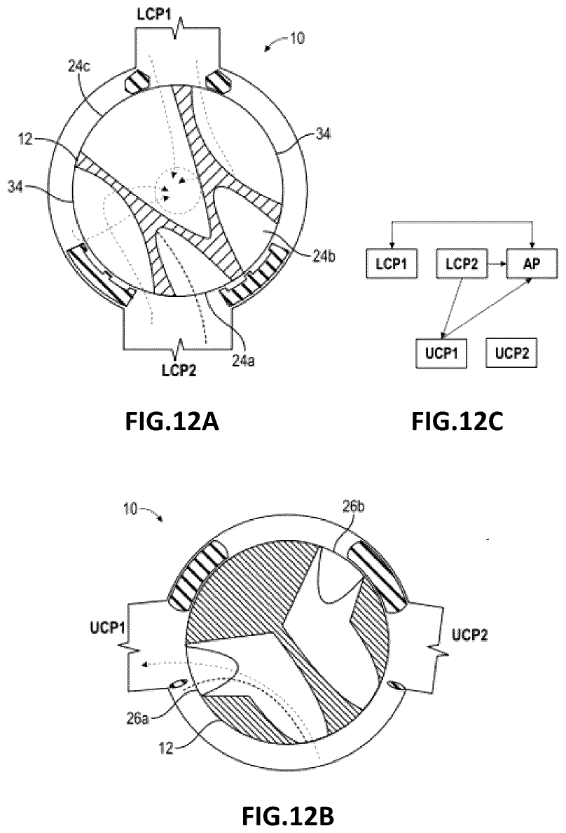

A transitionary state of the valve member 12 can be seen in FIGS. 12A to 12C, and is merely an example of any position which moves between the limits of proportionality from the respective first and second lower circumferential ports LCP1, LCP2. For instance, FIGS. 12A to 12C show an intermediate position when transitioning between the configuration of FIGS. 7A to 7C and that of FIGS. 11A to 11C.

The absence of a transitionary side panel on one side of the first upper sealing element 36c means that, even if the first lower circumferential opening 24a and thus first flow channel 22a remains in fluid communication with the second lower circumferential port LCP2, there will be significant loss of pressure by escape of fluid around the body 16, which should drain into the axial port AP. There will also be significant pressure loss through the surge-prevention opening 34 which is now in at least partial communication with the second lower circumferential port LCP2, allowing draining of fluid through the axial port AP.

This behaviour eliminates or at least substantially reduces the effect of a fluid hammer within the system. Noise generation is significantly reduced due to the loss of fluid pressure, as fluid cannot impact against the body 16 of the valve member 12 with any great force.

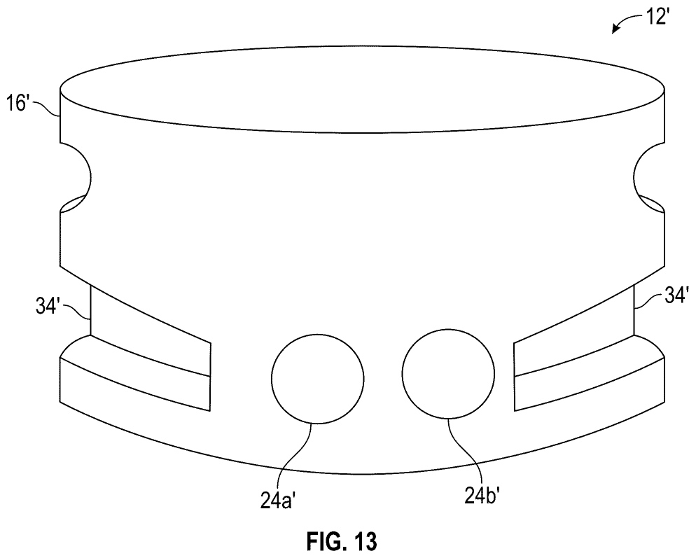

One exemplary design of valve member 12′ is shown in FIG. 13. The surge-prevention openings 34′ are dimensioned so as to be or substantially be trapezoidal, increasing in height away from the first and second lower circumferential openings 24a′, 122b′. This increase in discharge area through the surge-prevention openings 34′ can be calculated to minimise noise which might be caused by overlap of the body 16′ with one of the lower circumferential ports LCP1, LCP2 during transitionary rotation.

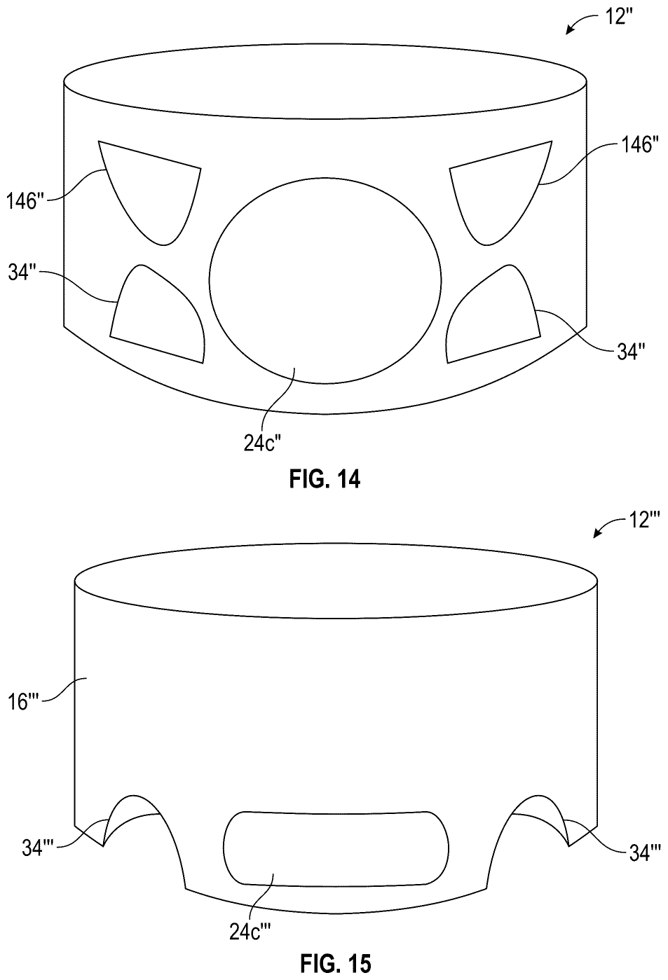

An alternative design of valve member 12″ is shown in FIG. 14, which shows upper and lower surge prevention openings 34″ at or adjacent to a third lower circumferential opening 24c″. A further alternative design of valve member 12′″ is shown in FIG. 15, which shows surge prevention openings 34′″ at or adjacent to a third lower circumferential opening 24c′″ and which have no lower bounding on the body 16″ ″.

It is noted that in none of the embodiments shown is there any need for an axial seal. The fluid pressure pushes the valve member towards the actuator direction, avoiding any additional sealing requirement.

It is therefore possible to provide a multi-port valve which is capable of providing both proportional flow control, particularly but not necessarily exclusively for the coolant system of an electric vehicle, as well as crossing functionality between different loops of the said system. The multi-port valve is highly suited towards use in electric vehicles, as it has the capability of preventing or significantly reducing fluid hammer effects within the coolant system, which are loud and undesirable in vehicles having quieter engines or motors. The combination of the proportionality and crossing functions also reduce the cost and complexity of the valve control arrangement, as the valve can be operated via a single drive actuator.

The words ‘comprises/comprising’ and the words ‘having/including’ when used herein with reference to the present invention are used to specify the presence of stated features, integers, steps, or components, but do not preclude the presence or addition of one or more other features, integers, steps, components, or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A multi-port valve comprising:
a valve housing having an axial port and a plurality of circumferential ports;
a valve member having at least two flow channels therethrough, the valve member being movable within the valve housing about an axis to alter a fluid flow through the multi-port valve by changing the position of the at least two flow channels, wherein at least one proportional flow condition is achievable between the plurality of circumferential ports; and
a sealing arrangement positioned between the valve housing and the valve member, the valve member being movable relative to the sealing arrangement, the sealing arrangement comprising a seal associated with each of the plurality of circumferential ports;
characterised in that the seal associated with a second lower circumferential port is a surge seal which is provided as part of an elongate sealing element having a central seal and transitionary seal panels either side of a sealing rib of the central seal with respect to the circumferential direction.

2. The multi-port valve as claimed in claim 1, wherein the valve member includes at least one surge-prevention opening therein to provide a surge-prevention pathway to the axial port.

3. A multi-port valve as claimed in claim 2, wherein the at least one surge-prevention opening is non-circular.

4. A multi-port valve as claimed in claim 3, wherein the at least one surge-prevention opening is trapezoidal in the circumferential direction of the valve member.

5. A multi-port valve as claimed in claim 1, wherein the plurality of circumferential ports comprises at least one upper circumferential port and at least one lower circumferential port, the upper and lower circumferential ports being spaced apart in the axial direction of the valve member.

6. A multi-port valve as claimed in claim 5, wherein there are two said upper circumferential ports and two said lower circumferential ports.

7. A multi-port valve as claimed in claim 5, wherein the seal associated with the first lower circumferential port is dimensioned to the first lower circumferential port.

8. A multi-port valve as claimed in claim 1, wherein the elongate sealing element includes intermediate sealing ribs in the transitionary seal panels to prevent leak between adjacent the at least one surge-prevention opening and at least one lower circumferential opening of the valve member during movement of the valve member.

9. A multi-port valve as claimed in claim 8, wherein the elongate sealing element further comprises an at least in part perimetric seal.

10. A multi-port valve as claimed in claim 1, wherein the seal associated with the first and/or second upper circumferential ports is provided on a seal element having a single transitionary seal panel to one side of a sealing rib of the seal in one circumferential direction.

11. A multi-port valve as claimed in claim 10, wherein the seal associated with the first and/or second upper circumferential ports further comprises an at least in part perimetric seal.

12. A multi-port valve as claimed in claim 1, wherein the valve member comprises first and second said flow channels, the first flow channel extending from a first lower circumferential opening to a first upper circumferential opening of the valve member, and the second flow channel extending from a second lower circumferential opening to a second upper circumferential opening of the valve member.

13. A multi-port valve as claimed in claim 12, wherein the valve member further comprise a third flow channel formed as a void extending from a third lower circumferential opening to an axial opening, the at least one surge-prevention opening being fluidly communicable with the void.

14. A multi-port valve as claimed in claim 5, wherein there is at least one proportional flow condition from the first lower circumferential port to the first and second upper circumferential ports, and at least one proportional flow condition from the second lower circumferential port to the first and second upper circumferential ports.

15. A multi-port valve as claimed in claim 1, wherein each seal is provided as a protruding rim relative to a surface of an associated sealing element.

16. A coolant system for a motor vehicle, the coolant system comprising at least one multi-port valve as claimed in claim 1.
